(19) United States
(12) Patent Application Publication
(10) Pub. No.: US 2014/0146409 A1
(43) Pub. Date: May 29, 2014

(54) REFLECTING MIRROR, AND A METHOD OF MANUFACTURING THE REFLECTING MIRROR

(71) Applicant: Kazuki Anjou, Kashima-city, Ibaraki (JP)

(72) Inventor: Kazunori Isakai, Kashima-city (JP)

(73) Assignees: Kazuki ANJYOU, Kashima-city, Ibaraki (JP); Kazunori ISAKAI, Kashima-city, Ibaraki (JP)

(21) Appl. No.: 14/130,207

(22) PCT Filed: Jun. 27, 2012
(86) PCT No.: PCT/JP2012/004165

§ 371 Date: Dec. 30, 2013

(30) Foreign Application Priority Data
Jul. 5, 2011 (JP) 2011-149153
Feb. 3, 2012 (JP) 2012-022006

(51) Int. Cl. B24C 1/04; G02B 5/08

(52) U.S. Cl. CPC B24C 1/045; G02B 5/08
USPC 359/884; 451/38

(57) ABSTRACT

[Problems]

It is an object of the present invention to provide an ornament of a reflecting mirror having a complicated design.

[Means of solving the problems]

A method of manufacturing a reflecting mirror according to the present invention is characterized by having a light transmittance medium capable of transmitting a light and a coated layer surface for reflecting light which is placed at the light transmittance medium, wherein the light transmittance medium is cut by the water-jet machining through a protected member set at a coated face side of the coated layer surface. A reflecting mirror according to the present invention is characterized in that the reflecting mirror has a light transmittance medium capable of transmitting a light and a coated layer surface for reflecting light which is placed at the light transmittance medium, wherein in the case that a face opposite to the coated layer surface is a face of the light transmittance medium, the reflecting mirror has a cutting surface other than the coated layer surface and the face, and a surface roughness of the cutting surface is rougher than the face of the light transmittance medium, and the cutting surface is a cutting surface which is cut by the water-jet machining through a protected member set at a coated face side of the coated layer surface.

### TECHNICAL FIELD

The present invention relates to a reflecting mirror, and a method of manufacturing the reflecting mirror.

### BACKGROUND ART

As an ornament produced by using a mirror in the past, there are only those of simple shapes, such as quadrangle, round shape, elliptic type, sector form. That is because it was manufactured by making a scratch on a surface using a diamond cutter by manual procedures at everything, that is, a process of something like a cracking than a cutting off.

It was difficult for this manufacturing process to manufacture a complicated product and it was impossible to hollow out a product. Although it is possible to manufacture a complicated product such as metal products, plastic article other than mirror by using laser beam machining, in the case of mirror, it is impossible to use laser beam machining.

And recently, consumer needs increase demand of a mirror having not only a simple shape but a complicated design.

For example, as an interior mirror, an ornamental glass is known that is characterized by giving a distinctive design by means of a sand blast process and a glue to obtain a crystal glass and thereby carrying out a silvering process of the crystal glass (“Patent Literature 1.”).

### PRIOR ART LITERATURE

### Patent Literature

Patent Literature 1 JP-A-H06-83743 (Utility model)

### DISCLOSURE OF THE INVENTION

### Problems to be Resolved by the Invention

However, the above Patent Literature 1 only discloses a method of cutting or using a glue to give a random image, design and pattern on so-called front face (not side surface) of a mirror. That is, the prior art is not characterized by cutting a side surface of a mirror. In this way, although it is possible to treat only a front face of a mirror without cutting a mirror, it is difficult to manufacture a commercialized product because a lot of cracking occur when a mirror is finely and intricately cut.

Therefore, to solve the above mentioned problem, Therefore, it is an object of the present invention to provide an ornament of a reflecting mirror having a complicated design

### Means of Solving the Problems

In order to accomplish the above object, the present inventor made strenuous studies as to a reflecting mirror and a method of producing the reflecting mirror, as a result of this, found the present invention.

A method of manufacturing a reflecting mirror according to the present invention is characterized by having a light transmittance medium capable of transmitting a light and a coated layer surface for reflecting light which is placed at the light transmittance medium, wherein the light transmittance medium is cut by the water-jet machining through a protected member set at a coated face side of the coated layer surface.

Furthermore, in a preferred embodiment of the method of manufacturing a reflecting mirror according to the present invention, the method is characterized in that a pencil hardness of the protected member is a H or more.

Furthermore, in a preferred embodiment of the method of manufacturing a reflecting mirror according to the present invention, the method is characterized in that the cutting by the water-jet machining is carried out under the presence of a polishing agent.

Furthermore, in a preferred embodiment of the method of manufacturing a reflecting mirror according to the present invention, the method is characterized in that the cutting by the water-jet machining is carried out under the condition of a water pressure in a range of 10 to 500 MP.

Furthermore, in a preferred embodiment of the method of manufacturing a reflecting mirror according to the present invention, the method is characterized in that the cutting by the water-jet machining is carried out under the condition of a processing velocity in a range of 1 to 15000 mm/min.

Furthermore, in a preferred embodiment of the method of manufacturing a reflecting mirror according to the present invention, the method is characterized in that an amount of supply of the polishing agent is 10 to 300 g/min.

A reflecting mirror according to the present invention is characterized in that the reflecting mirror has a light transmittance medium capable of transmitting a light and a coated layer surface for reflecting light which is placed at the light transmittance medium, wherein in the case that a face opposite to the coated layer surface is a face of the light transmittance medium, the reflecting mirror has a cutting surface other than the coated layer surface and the face, and a surface roughness of the cutting surface is rougher than the face of the light transmittance medium, and the cutting surface is a cutting surface which is cut by the water-jet machining through a protected member set at a coated face side of the coated layer surface.

Furthermore, in a preferred embodiment of the reflecting mirror according to the present invention, the reflecting mirror is characterized in that a pencil hardness of the protected member is a H or more.

Furthermore, in a preferred embodiment of the reflecting mirror according to the present invention, the reflecting mirror is characterized in that the cutting surface is a surface cut by the water-jet machining under the presence of a polishing agent.

Furthermore, in a preferred embodiment of the reflecting mirror according to the present invention, the reflecting mirror is characterized in that the light transmittance medium is made of glass or acrylic.

An ornament reflecting mirror according to the present invention is characterized in that the ornament reflecting mirror is made by combination of a part which is made by the reflecting mirror according to the present invention.

Furthermore, in a preferred embodiment of the ornament reflecting mirror according to the present invention, the ornament reflecting mirror is characterized in that the part is a mirror having a different color of reflection.

### Effect of Invention

The present invention has an advantage effect that it is possible to produce a reflecting mirror having a high accuracy without cracking even if a reflecting mirror is cut and designed by a complicated design such as a character, a character image. Further, the present invention has an advantage effect that it is possible to produce a reflecting mirror having a higher quality by means of the combination of each part made by intricately cutting a mirror having a different color of reflection, or a design cutting of a simple substance.

### BRIEF DESCRIPTION OF THE DRAWINGS

FIG. 1 gives a flowchart showing a method of manufacturing a reflecting mirror in an example embodiment according to the present invention.

FIG. 2 gives an example of a designed ornament of a reflecting mirror made by a method of manufacturing a reflecting mirror according to present invention.

FIG. 3 gives an example of an abrasive head.

FIG. 4 gives an aspect of cutting by so-called table mobile type of the water-jet machining.

FIG. 5 gives an aspect of cutting by so-called nozzle mobile type of the water-jet machining.

FIG. 6 gives an example of a reflecting mirror according to the present invention.

FIG. 7 gives a comparison of a cutting face of a garnet #80 and a #120 (A comparison according to a difference of a grain size of the polishing agent). (A) is in the case of #80 as a grain size of the polishing agent, (B) is in the case of #120. as a grain size of the polishing agent, respectively. It is recognized that the make up products of #80 are rougher than those of #120.

FIG. 8 gives a reflecting mirror cut by the water-jet machining without a protected member. It is recognized that an encircled portion of the figure is a trace of a scratch depending on the splattering of water from the water-jet machining, a coated layer of reflection of a reflecting mirror is broke away.

FIG. 9 gives an enlarged illustration of an encircled portion of a trace of the scratch shown in a third circle from right side of FIG. 8.

FIG. 10 gives a reflecting mirror cut by the water-jet machining through a protected member having a H or more of a pencil hardness, and a thickness of the protected member is 1 mm.

FIG. 11 gives a reflecting mirror cut by the water-jet machining through a protected member having a H or more of a pencil hardness, and a thickness of the protected member is 5 min.

### MODE FOR CARRYING OUT THE INVENTION

A reflecting mirror according to the present invention is characterized in that the reflecting mirror has a light transmittance medium capable of transmitting a light and a coated layer surface for reflecting light which is placed at the light transmittance medium, wherein in the case that a face opposite to the coated layer surface is a face of the light transmittance medium, the reflecting mirror has a cutting surface other than the coated layer surface and the face, and a surface roughness of the cutting surface is rougher than the face of the light transmittance medium. At first, the light transmittance medium is not particularly limited as long as it can transmit a light. As the light transmittance medium, mention may be made of glass, acrylic, plastic, and polyester etc. Further, it is possible to set the coated layer surface for reflecting light on any face of the light transmittance medium. The coated layer surface makes it possible to reflect a light and thereby working it as so-called mirror. As a material of the coated layer surface, it is not particularly limited according to the common procedure, but for example, it is possible to use metal such as aluminum and silver etc. It is possible to evaporate these metal such as aluminum, silver on the light transmittance medium according to the common procedure to form the coated layer surface.

Further, the present invention is characterized in that in the case that a face opposite to the coated layer surface is a face of the light transmittance medium, the reflecting mirror has a cutting surface other than the coated layer surface and the face, and a surface roughness of the cutting surface is rougher than the face of the light transmittance medium. This roughness of the cutting surface gives a slight shiny, posh surface and sense of beauty, in the case of looking in a mirror from variable angle. The cutting surface may be perpendicular to the surface of the light transmittance medium, or it may be a diagonal cutting if it is in a range of ±90. It is possible to design appropriately according to a desired final product.

Further, in the present invention, it is possible to scratch the coated layer surface to give an outline such as a line, a graphic, a character design etc. When the line is drew, this is because that the trimming of the coated layer surface along with the line makes it possible to pop up the line. It is possible to trim a part of the coated layer surface of an outline portion of an eye, a nose, a mouth etc of a character design to draw it.

The present invention is characterized in that in the case that a face opposite to the coated layer surface is a face of the light transmittance medium, the reflecting mirror has a cutting surface other than the coated layer surface and the face, and a surface roughness of the cutting surface is rougher than the face of the light transmittance medium. In general, when the light transmittance medium is broke up or clacked, roughness of the face of the light transmittance medium is the same as that of the cutting surface and the broken surface is transparent. In the present invention, the cutting surface is rougher than the broken surface. In addition to this, in preferable embodiment, the cutting surface is not transparent. The existence of the portion of the rougher cutting surface and opaque glass may be similar to the design of so-called cut glass etc., and thereby making it possible to produce a reflecting mirror having very expensive texture. The cutting surface is also similar to a frosted glass. In a preferable embodiment, the present invention has an advantage effect that the existence of the portion of such opaque glass as a part makes it possible to generate not only a diffuse reflection of light but a clear and excellent sense of beauty and expensive texture.

Furthermore, in a preferred embodiment of the reflecting mirror according to the present invention, the cutting surface is a cutting surface which is cut by the water-jet machining. That is, in a preferred embodiment, the reflecting mirror and the ornament reflecting mirror according to the present invention may have a portion made by the water-jet machining. A condition of the water-jet machining is not particularly limited. It is possible to appropriately design it depending on a desired quality of the end products such as an ornament, a reflecting mirror, a compact mirror etc.

The explanation of the conditions of the water-jet machining are as follows. For example, it is possible to be 10 to 500 MPa regarding a water pressure. Regarding a water pressure, from a viewpoint that a product with a higher quality can be obtained, preferably it is possible to be 100 to 350 MPa, more preferably it is possible to be 200 to 320 MPa. Moreover, it is possible to be 20 to 40 MPa regarding a cutting of a portion so-called pierce which is not related to the end products. The conditions of cutting thereof is important even if such portion of so-called pierce is not directly related to the end products. This is because that there are some problems such as a yield ratio when a clacking is generated in the portion of pierce and thereby the clacking arriving in a portion of glass etc., used as the end product. From a viewpoint of this, it is also needed to be design regarding the conditions of cutting of the portion of pierce.

Moreover, a nozzle hole diameter of the water-jet machining is also not particularly limited. Among nozzle hole diameters, a nozzle hole diameter of water portion, for example may be 0.1 to 1 mm, preferably 0.1 to 0.45 mm, more preferably 0.15 to 0.25 mm. Among nozzle hole diameters, a nozzle hole diameter in the case of adding an abrasive (a polishing agent) may be 0.4 to 2 mm, preferably 0.5 to 1.0 mm, more preferably, 0.6 to 0.9 mm.

Furthermore, a flow rate of water of the water-jet machining is also not particularly limited, but it is possible to design appropriately it according to a quality of the needed desired final product. For example, the flow rate may be 0.1 to 15 L/min, from a viewpoint that it is possible to obtain a product having more high quality, preferably 0.5 to 3.0 L/min, more preferably 0.7 to 2.0 L/min.

Furthermore, a processing velocity of the water-jet machining is also not particularly limited. For example, it may be 1 to 15000 mm/min, from a viewpoint that the final product may be shaped into more high quality, 10 to 500 mm/min, 50 to 150 mm/min. Although the final product may by shaped into more high quality if the processing velocity is slow, a constant velocity is needed on account of the mass productivity because it requires additional time in the case of slow speed.

Furthermore, in a preferable embodiment of the reflecting mirror according to the present invention, the mirror is characterized in that the cutting surface is a cutting surface which is cut by the water-jet machining under the condition of the presence of the polishing agent. The polishing agent is not particularly limited, but for example, mention may be made of alumina, SiO₂, garnet, glass bead etc. For example, in the case of garnet, a grain size within a range of #30 to #400 may be used, it tends to be shaped into a rougher product as the number of the range of the grain size.

An amount of supply of the polishing agent is also not particularly limited. For example, depending on the require of the quality of final product, the amount of supply of the polishing agent may be 10 to 300 g/min. The amount of supply as to the portion of the cutting surface is preferably 60 to 200 g/min from a viewpoint of a beautiful finish, more preferably 100 to 170 g/min. Moreover, the amount of supply as to the portion of the pierce may be 30 to 90 g/min, preferably 50 to 70 g/min.

In the case of the cutting according to the water-jet machining, although it is possible to produce a desired design cutting, there are any requirement for preventing removing of the coated layer surface. If the coating agents such as metal of the coated layer surface are removed, it may be not ideal for use in a mirror etc., because the removed portion of the coated layer can not reflect the light. In such a case, it may maintenance and correct the removed surface. Moreover, it is important to carry out the cutting which does not generate removal of the coated layer surface.

Therefore, in order to prevent the removal of the coated agent such as metal etc., used for the coated layer surface, in the preferable embodiment of the reflecting mirror according to the present invention, the cutting surface may be made by the water-jet machining through a protected member set at a coated face side of the target reflecting mirror which should be cut. The presence of the protected member makes it possible to prevent the removal of the coated layer of the reflecting mirror from reflection of a high pressure water or a used polishing agent etc., according to the water-jet machining.

Such protected member is not particularly limited as long as it is possible to prevent the removal of the coated layer. For example, as the protected member, mention may be made of sponge, board such as a veneered wood, rubber, glass etc. The thickness of the protected member is not particularly limited, but it depends on a required quality of the final product of the reflecting mirror or the used protected member. For example, it is possible to design an appropriate range, in the case of sponge, it is 3 to 10 mm, in the case of glass, it is 1 to 10 mm. In the case of glass, preferably, it is 1 to 5 mm, from a viewpoint of economical efficiency, more preferably, it is 1 to 3 mm.

From a viewpoint that it is possible to produce a reflecting mirror having an excellent quality, in a preferable embodiment, the mirror is characterized in that a pencil hardness of the protected member is a H or more. If the pencil hardness is less than a H, although there are no problems as to the glass portion of the reflecting mirror, the removal may generate in the coated layer surface for reflection. From a viewpoint that it is possible to produce a reflecting mirror having an excellent quality, the pencil hardness of the protected member is a H or more, more preferably a 2H or more. Furthermore, although it is thought that there are various sort such as glass, resin as a material of the protected member, preferably it is made of resin from a viewpoint that a certain level of friction is kept at the time of processing, the yield rate is increased, and it is easy to process. Although it is possible to use glass, it is tend that it is difficult to process in an orderly fashion because a slide between the reflecting mirror and the protected member will occur at the time of processing. It may add further a member for preventing a slide between the reflecting mirror and the protected member in the case that a slippery material such as glass etc., is used as the protected member.

Those of JIS K5600-5-4 standard may be used as the pencil hardness. The pencil hardness means that a lead of a pencil is pushed and moved on the sample surface, a scratch hardness of the sample is expressed by a hardness of a lead of a pencil (6B to HB to 6H etc.) depending on existence or nonexistence of the scratch. It is generally used as evaluation method of hardness of the surface of plastic or coating etc.

A pencil is set at an angle of 45°, and thereby driving a surface of the sample to measure. The summary of the method of measuring the pencil hardness is as follows: 1) it is confirmed that it is in a horizontal position, 2) it is drove at a constant speed, for example, at a speed of 0.5 to 1.0 mm for a few mm of interval, 3) in the case that there is a scratch or a stamp, a softer pencil scale is selected to find out a pencil scale that there are no scratches or stamps, on the other hand, in the case that there is no scratch or stamp, a harder pencil scale is selected to find out a pencil scale that can give a scratch to the sample.

Moreover, according to a preferable embodiment, the invention is characterized in that in other parameter, the Rockwell hardness (a method of test: JISK7202, unit: M scale) is 55 or more. If the Rockwell hardness is less than 55, although there are no problems as to the glass portion of the reflecting mirror, the removal may generate in the coated layer surface for reflection. From a viewpoint that it is possible to produce a reflecting mirror having an excellent quality, the Rockwell hardness of the protected member is 55 or more, more preferably 75 or more, further preferably 98 or more. Although the upper level is not particularly limited but, it is possible to prevent the removal of the coated layer surface at back side by the water-jet machining if the hardness is higher. Although it may be possible to prevent the removal of the coated layer surface of the reflecting mirror even if the hardness is less than the above hardness value by means of the careful management of working process, the above range of hardness may be preferable from a viewpoint of simplification of the manufacturing process.

Moreover, in the other embodiment, as the protected member, it is possible to use a plate glass consisting of the same material as the reflecting mirror. The explanation of prescription as to the protected member by using determination of degree of hardness for glass etc., such as the Mohs hardness, the Vickers hardness are as follows.

That is, according to the other parameter, from a viewpoint that the Mohs hardness of glass is generally 6.5 degree, the Mohs hardness of the protected member is preferably 6.5 degree or more. The Mohs hardness is a measurement method of hardness characterized by deciding ten various types of pure mineral substances as a standard in turn from a soft mineral substance to compare it with the standard.

Furthermore, according to the other parameter, from a viewpoint that the Vickers hardness of glass is generally 548 kg/mm², as the Vickers hardness of the protected member, those of 548 kg/mm² or more is preferably used. The measurement according to the Vickers hardness comprise at first, pressing a pyramid type of penetrator made by a regular quadrangular pyramid of diamond with α=136 of an angle between the opposite faces, into the sample surface, and after removing load, calculating superficial area S (mm²) from a length d (mm) of the diagonal line of the remaining dents. And then, a test load F (N) divided by the calculated superficial area S (mm²) can make the Vickers hardness (HV) of the sample.

Thus obtained reflecting mirror renders very expensive impression because the cutting surface is similar to those of a frosted glass or a facetted glass. It is possible to use as a compact mirror or a hand mirror if a verge or a frame are added in concert with the cutting surface. It is possible to grind down a part of the coated layer surface to newly produce a letter, a graphic or a design etc., to the reflecting mirror. Although the reflecting mirror is originally so-called mirror which is produced and based on the so-called routine shape such as an oblong figure or round shape, it is possible to produce a design cutting mirror according to a desired original picture in the present invention.

An ornament reflecting mirror according to the present invention is characterized in that the ornament reflecting mirror is ornamentalized and made by combination of a part which is made by the reflecting mirror according to the present invention. The use of the cut reflecting mirror as a part makes it possible to produce a mirror having an expensive texture or a distinctive sense of beauty which is similar to so-called cut glass, because each part has a cutting surface, that is, the part has a cutting surface made by for example, the water-jet machining, and the cutting surface is rougher comparing with a surface of the reflecting mirror.

The ornament reflecting mirror has an advantage effect that an ornament reflecting mirror has also expensive impression because the ornament reflecting mirror is made by the combination of the part of the reflecting mirror wherein each part has a cutting surface and can generate an expensive impression.

Furthermore, in a preferred embodiment of the ornament reflecting mirror according to the present invention, the ornament reflecting mirror is characterized in that the part is a mirror having a different color of reflection. The organization made by a portion or all of the part according to the different color of reflection makes it possible to produce not only the expensive impression of the cutting surface, in addition to this, but additional expensive impression.

Next, the explanation of a method of manufacturing a reflecting mirror according to the present invention is as follows.

A method of manufacturing a reflecting mirror according to the present invention is characterized by having a light transmittance medium capable of transmitting a light and a coated layer surface for reflecting light which is placed at the light transmittance medium, wherein the light transmittance medium is cut by the water-jet machining.

In the present invention, the light transmittance medium is not particularly limited as long as it can transmit a light. As the light transmittance medium, mention may be made of glass, acrylic, plastic, and polyester etc. Further, it is possible to set the coated layer surface for reflecting light, on any face of the light transmittance medium. The coated layer surface makes it possible to reflect a light and thereby working it as so-called mirror. As a material of the coated layer surface, it is not particularly limited according to the common procedure, but for example, it is possible to use metal such as aluminum and silver etc. It is possible to evaporate these metal such as aluminum, silver on the light transmittance medium according to the common procedure to form the coated layer surface.

The cutting by the water-jet machining has a feature that it can be attain to reduce a cost of maintenance or manufacturing etc., because water is generally and comparatively easy to control, and it is possible to precisely cut, and it is noncontact process. A condition of the water-jet machining is also particularly limited to anyone as long as it is possible to cut the reflecting mirror. As to a condition, it is possible to appropriately design it depending on a desired quality of the end products such as an ornament, a reflecting mirror, a compact mirror etc.

The explanation of the conditions of the water-jet machining are as follows. For example, it is possible to be 10 to 500 MPa regarding a water pressure. Regarding a water pressure, preferably it is possible to be 100 to 350 MPa, more preferably it is possible to be 200 to 320 MPa. Moreover, it is possible to be 20 to 40 MPa regarding a cutting of a portion so-called pierce which is not related to the end products.

Moreover, a nozzle hole diameter of the water-jet machining is also not particularly limited. Among nozzle hole diameters, a nozzle hole diameter of water portion, for example may be 0.1 to 1 mm, preferably 0.1 to 0.45 mm, more preferably 0.15 to 0.25 mm. Among nozzle hole diameters, a nozzle hole diameter in the case of adding an abrasive (a polishing agent) may be 0.4 to 2 mm, preferably 0.5 to 1.0 mm, more preferably, 0.6 to 0.9 mm.

Furthermore, a flow rate of water of the water-jet machining is also not particularly limited, but it is possible to design appropriately it according to a quality of the needed desired final product. For example, the flow rate may be 0.1 to 15 L/min, preferably 0.5 to 3.0 L/min, more preferably 0.7 to 2.0 L/min.

Furthermore, a processing velocity of the water-jet machining is also not particularly limited. For example, it may be 1 to 15000 mm/min, from a viewpoint that the final product may be shaped into more high quality, 10 to 500 mm/min, 50 to 150 mm/min. Although the final product may by shaped into more high quality if the processing velocity is slow, a constant velocity is needed on account of the mass productivity because it requires additional time in the case of slow speed.

Furthermore, in a preferable embodiment of the method of manufacturing a reflecting mirror according to the present invention, the method is characterized in that the cutting by the water-jet machining is carried out under the condition of the presence of the polishing agent. The polishing agent is not particularly limited, but for example, mention may be made of alumina, SiO₂, garnet, glass bead etc. For example, in the case of garnet, a grain size within a range of #30 to #400 may be used, it tends to be shaped into a rougher product as the number of the range of the grain size.

Furthermore, in a preferable embodiment of the method of manufacturing a reflecting mirror according to the present invention, the method is characterized in that an amount of supply of the polishing agent is 10 to 300 g/min. The amount of supply as to the portion of the cutting surface is preferably 60 to 200 g/min from a viewpoint of a beautiful finish, more preferably 100 to 170 g/min. Moreover, the amount of supply as to the portion of the pierce may be 30 to 90 g/min, preferably 50 to 70 g/min.

In the case of the cutting according to the water-jet machining, although it is possible to produce a desired design cutting, there are any requirement for preventing removing of the coated layer surface. If the coating agents such as metal of the coated layer surface are removed, it may be not ideal for use in a mirror etc., because the removed portion of the coated layer can not reflect the light. In such a case, it may maintenance and correct the removed surface. Moreover, it is important to carry out the cutting which does not generate removal of the coated layer surface.

Therefore, in order to prevent the removal of the coated agent such as metal etc., used for the coated layer surface, in the preferable embodiment of the method of manufacturing a reflecting mirror according to the present invention, the cutting surface may be made by the water-jet machining through a protected member set at a coated face side of the target reflecting mirror which should be cut. The presence of the protected member makes it possible to prevent the removal of the coated layer of the reflecting mirror from reflection of a high pressure water or a used polishing agent etc., according to the water-jet machining.

Such protected member is not particularly limited as long as it is possible to prevent the removal of the coated layer. For example, as the protected member, mention may be made of sponge, board such as a veneered wood, rubber, glass etc. The thickness of the protected member is not particularly limited, but it depends on a required quality of the final product of the reflecting mirror or the used protected member. For example, it is possible to design an appropriate range, in the case of sponge, it is 3 to 10 mm, in the case of glass, it is 1 to 10 mm. In the case of glass, preferably, it is 1 to 5 mm, from a viewpoint of economical efficiency, more preferably, it is 1 to 3 mm.

From a viewpoint that it is possible to produce a reflecting mirror having an excellent quality, in a preferable embodiment, the mirror is characterized in that a pencil hardness of the protected member is a H or more. If the pencil hardness is less than a H, although there are no problems as to the glass portion of the reflecting mirror, the removal may generate in the coated layer surface for reflection. From a viewpoint that it is possible to produce a reflecting mirror having an excellent quality, the pencil hardness of the protected member is a H or more, more preferably a 2H or more. Furthermore, although it is thought that there are various sort such as glass, resin as a material of the protected member, preferably it is made of resin from a viewpoint that a certain level of friction is kept at the time of processing, the yield rate is increased, and it is easy to process. Although it is possible to use glass, it is tend that it is difficult to process in an orderly fashion because a slide between the reflecting mirror and the protected member will occur at the time of processing. It may add further a member for preventing a slide between the reflecting mirror and the protected member in the case that a slippery material such as glass etc., is used as the protected member.

Those of JIS K5600-5-4 standard may be used as the pencil hardness. The pencil hardness means that a lead of a pencil is pushed and moved on the sample surface, a scratch hardness of the sample is expressed by a hardness of a lead of a pencil (6B to HB to 6H etc.) depending on existence or nonexistence of the scratch. It is generally used as evaluation method of hardness of the surface of plastic or coating etc.

A pencil is set at an angle of 45°, and thereby driving a surface of the sample to measure. The summary of the method of measuring the pencil hardness is as follows: 1) it is confirmed that it is in a horizontal position, 2) it is drove at a constant speed, for example, at a speed of 0.5 to 1.0 mm for a few mm of interval, 3) in the case that there is a scratch or a stamp, a softer pencil scale is selected to find out a pencil scale that there are no scratches or stamps, on the other hand, in the case that there is no scratch or stamp, a harder pencil scale is selected to find out a pencil scale that can give a scratch to the sample.

Moreover, according to a preferable embodiment, the invention is characterized in that in other parameter, the Rockwell hardness (a method of test: JISK7202, unit: M scale) is 55 or more. If the Rockwell hardness is less than 55, although there are no problems as to the glass portion of the reflecting mirror, the removal may generate in the coated layer surface for reflection. From a viewpoint that it is possible to produce a reflecting mirror having an excellent quality, the Rockwell hardness of the protected member is 55 or more, more preferably 75 or more, further preferably 98 or more. Although the upper level is not particularly limited but, it is possible to prevent the removal of the coated layer surface at back side by the water-jet machining if the hardness is higher. Although it may be possible to prevent the removal of the coated layer surface of the reflecting mirror even if the hardness is less than the above hardness value by means of the careful management of working process, the above range of hardness may be preferable from a viewpoint of simplification of the manufacturing process.

Moreover, in the other embodiment, as the protected member, it is possible to use a plate glass consisting of the same material as the reflecting mirror. The explanation of prescription as to the protected member by using determination of degree of hardness for glass etc., such as the Mohs hardness, the Vickers hardness are as follows.

That is, according to the other parameter, from a viewpoint that the Mohs hardness of glass is generally 6.5 degree, the Mohs hardness of the protected member is preferably 6.5 degree or more. The Mohs hardness is a measurement method of hardness characterized by deciding ten various types of pure mineral substances as a standard in turn from a soft mineral substance to compare it with the standard.

Furthermore, according to the other parameter, from a viewpoint that the Vickers hardness of glass is generally 548 kg/mm², as the Vickers hardness of the protected member, those of 548 kg/mm² or more is preferably used. The measurement according to the Vickers hardness comprise at first, pressing a pyramid type of penetrator made by a regular quadrangular pyramid of diamond with α=136° of an angle between the opposite faces, into the sample surface, and after removing load, calculating superficial area S (mm²) from a length d (mm) of the diagonal line of the remaining dents. And then, a test load F (N) divided by the calculated superficial area S (mm²) can make the Vickers hardness (HV) of the sample.

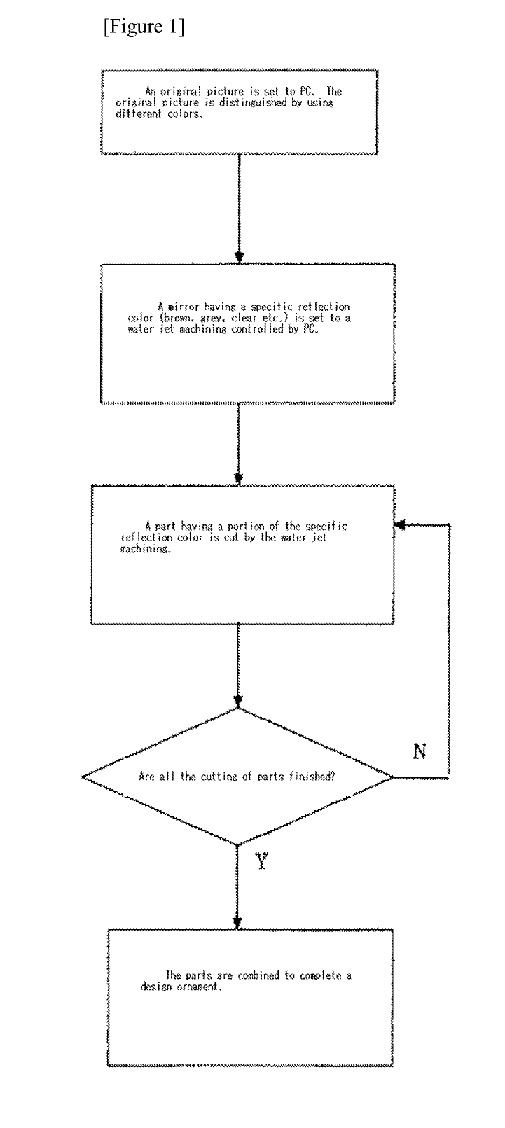

Next, an embodiment as an example according to the present invention will be explained with reference to figures. FIG. 1 gives a flowchart showing a method of manufacturing a reflecting mirror in an example embodiment according to the present invention. FIG. 1 gives a method of manufacturing an ornament reflecting mirror in an example according to the present invention, showing an example of a method of manufacturing an ornament reflecting mirror wherein the reflecting mirror according to the present invention is used as a part, the part is combined with each other to be ornamentalized.

At first, an original picture of the ornament reflecting mirror of the final produce is fed to a personal computer. In order to realize a design comprising the combination of mirrors having a different color of reflection, the setup of the personal computer will be carried out so that each color can be recognized. In FIG. 1, 1 to 16 show a part of the final product. For example, it is possible to be a clear color of the reflecting mirror as to 1 to 5, and be a grey color of the reflecting mirror as to 6 to 10, and be a brown color of the reflecting mirror as to 11 to 16. Moreover, all parts of 1 to 16 wherein each part has different colors may be used and comprised by sixteen colors. Moreover, all parts of 1 to 16 may be a clear color, a grey color or brown color etc., of the reflecting mirror. In such case, the ornament reflecting mirror is made by a whole-colored. Moreover, 1 to 16 may be cut as a part, a portion or all of the part may include a portion which is not cut in the boundary of the part. In the case that an outline is drew in a portion which is not cut, it is possible to give a design such as a line, shape etc., if the coated layer portion for reflecting is scratched as mentioned above.

The color of the reflecting color is not limited but, for example, only a portion corresponding to an eye may be red of the reflecting color. It is possible to change the color of the reflecting color for everything. In any event, it is possible to produce an ornament reflecting mirror haying a characteristic expensive texture because the cutting surface is rougher than that of so-called face.

For example, the explanation in the case of the use of brown, clear and grey as the reflecting color is as follows. At first, a mirror of the reflecting color (for example, brown) is set. And then, the personal computer controlled machine is set so that a part which should be made by a mirror of the reflecting color of brown could be cut.

Next, a mirror of a different reflecting color (for example, clear) is set. The personal computer controlled machine is set so that a part which should be made by a mirror of clear could be cut.

Hereinafter, in a similar manner, a part which should be made by each mirror of the reflecting color may be cut, and thereby combining these parts to produce a designed ornament.

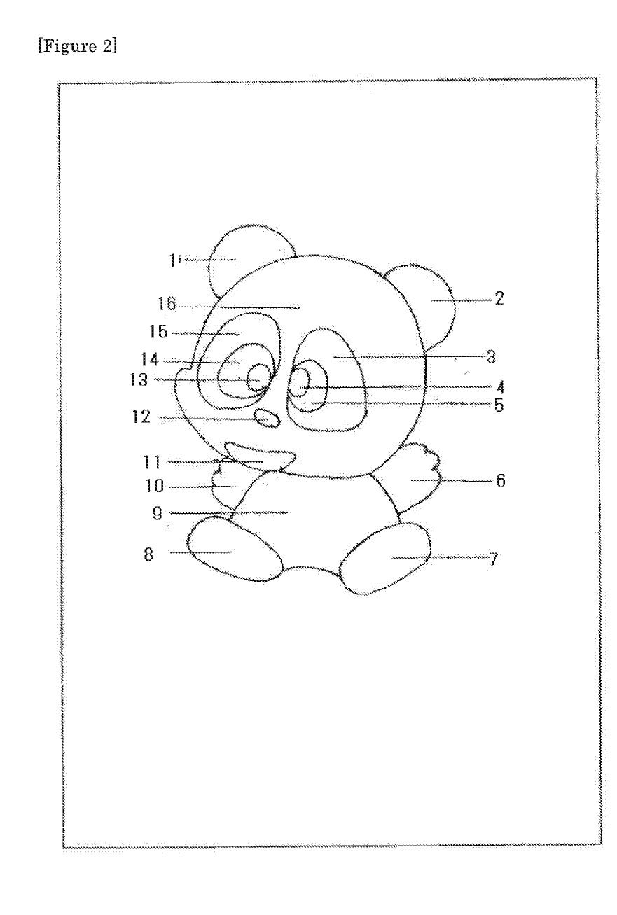

Next, FIG. 2 gives an example of a designed ornament made by the above method of manufacturing a reflecting mirror. FIG. 2 gives an example of a designed ornament of a reflecting mirror obtained by a method of manufacturing a reflecting mirror according to present invention.

FIG. 2 gives an example of an ornament in the motif of some animal. As mentioned above, the combination of a mirror of the reflecting colors such as clear, grey and brown makes it possible to design a picture of animal. The ornament may comprise single color such as, for example, clear, grey and brown or any color other than these colors. A various combination of a mirror of the reflecting color makes it possible to produce a various sort of a designed ornament.

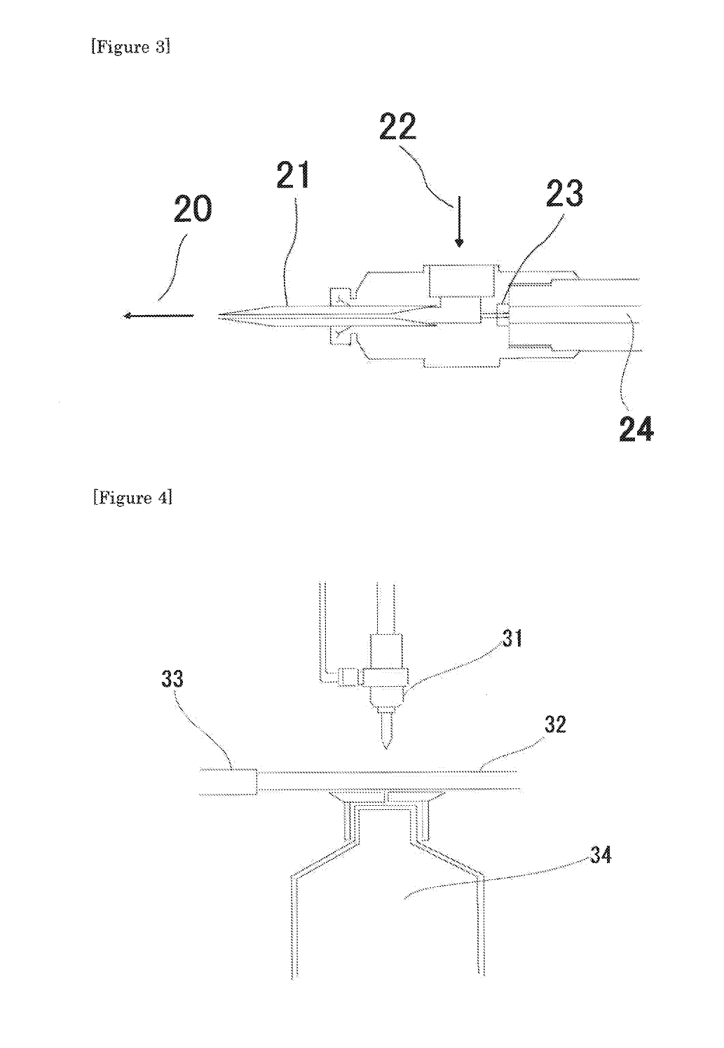

FIG. 3 gives an example of an abrasive head. 20 means an outlet of a superhigh pressure water, 21 means an abrasive nozzle, 22 means a feed port of an abrasive, 23 means a water nozzle, 24 means a feed port of a superhigh pressure water, respectively. Moreover, although a nozzle is shown in figure in the case of the use of the polishing agent, in the case that the polishing agent is not used, 21 and 22 etc., are not need. A superhigh pressure water is introduced from 24, the reflecting mirror may be cut through water nozzle 23. Further, in the case of the use of the polishing agent, the superhigh pressure water together with a desired polishing agent introduced from a feed port of the abrasive may emit a jet via an abrasive nozzle in the outlet 22 of the superhigh pressure water.

FIG. 4 gives an aspect of cutting by so-called table mobile type of the water-jet machining. 31 means an abrasive head (capable of moving for a direction of y-axis), 32 means an object of processing (capable of moving for a direction of x-axis), 33 means a work stopper, 34 means a slit catcher, respectively. In this type of mobile water-jet machining, all of the superhigh pressure water, polishing agent and scrap may be put in the catcher. Although there are some problems of noise comparing with those of the nozzle type, even so it is relatively low noise, because there is low rebound of water, and it is not cut in water as mentioned below machine which is so-called nozzle mobile type.

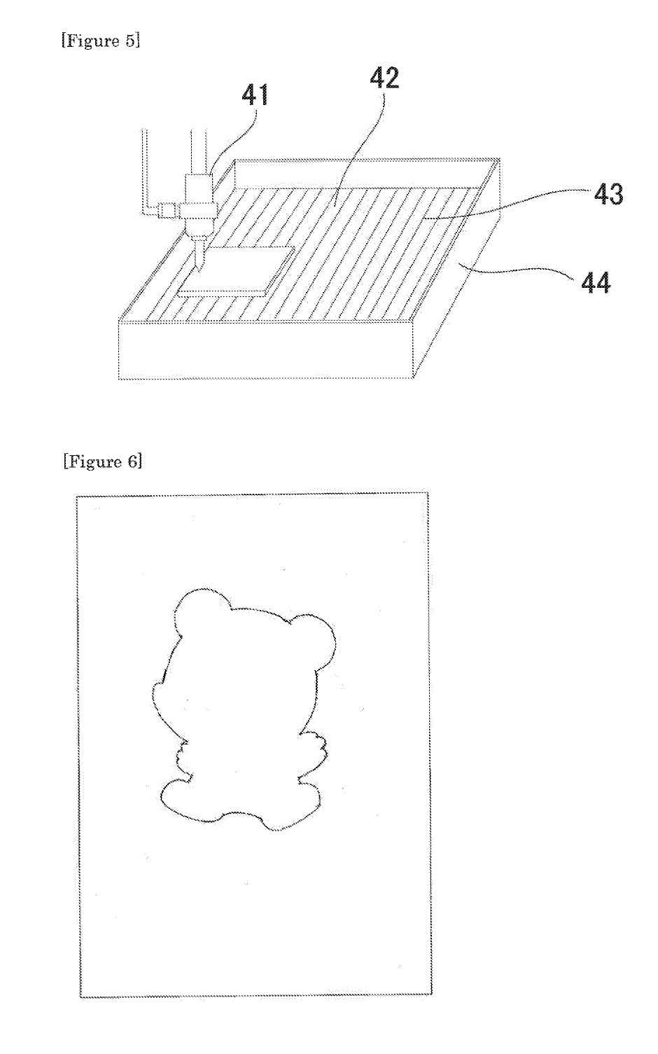

FIG. 5 gives an aspect of cutting by so-called nozzle mobile type of the water-jet machining. 41 means an abrasive head (capable of moving for a direction of x and y-axis), 42 means an open catcher (fixed), 43 means a stage, 44 means a catcher tank, respectively. This nozzle mobile type has a simple structure wherein a stainless steel plate (stage 43) is set on a catcher tank 44. The stainless steel plate (stage 43) may be a reticular pattern.

FIG. 6 gives an example of a reflecting mirror according to the present invention. A general reflecting mirror comprises the reflecting mirror having a light transmittance medium capable of transmitting a light and a coated layer surface for reflecting light which is placed at the light transmittance medium, wherein in the case that a face opposite to the coated layer surface is a face of the light transmittance medium, the general reflecting mirror has a side surface other than the coated layer surface and the face, and a surface roughness of the side surface is the same as the face of the light transmittance medium, because the general reflecting mirror is obtained by an integral moulding etc., itself. Moreover, the side surface is clear. Even if the light transmittance medium is cut, the side surface is still clear, and the surface roughness of the side surface is the same as that of the face of the light transmittance medium.

On the other hand, in the reflecting mirror according to the present invention, the mirror has a cutting surface and a surface roughness of the cutting surface is rougher than the face of the light transmittance medium. This roughness make it possible to generate a special kind of a expensive texture to the final product of the reflecting mirror. A desired design shape is produced to polish it by sandblast etc., so as to obtain a frosted glass or a cut glass etc., and thereby making it possible to produce a rougher surface of the cut surface than the face of the light transmittance medium. From a viewpoint of a mass productivity or a low cost, the cutting surface is preferably cut by the water-jet machining. That is, the reflecting mirror according to the present invention may have a cutting portion obtained by the water-jet machining. This is the same as those of a single product or an ornament reflecting mirror obtained by the combination of the part of the reflecting mirror.

### EXAMPLE

At this moment, the present invention will be concretely explained in more detail with reference to Examples, but the invention is not intended to be interpreted as being limited to Examples. Moreover, it is possible to change appropriately without departing from the scope of the invention.

### Example 1

At first, in order to produce a rougher cutting surface of the reflecting mirror, from a viewpoint of a mass productivity, the cutting by the water-jet machining was made an attempt.

At first, a reflecting mirror and a cutting surface of glass according to various sort of a processing velocity was evaluated. Among the water-jet machining, those of so-called mobile type was used and the cutting was carried out under water. As the water pressure, in the reflecting mirror it was 300 MPa, in the so-called pierce which is a portion of no relationship with the final product, it was 30 MPa. As a flow rate, in the reflecting mirror it was 1.1 L/min, in the pierce it was 0.35 L/min. 0.2 mm of the nozzle diameter was used.

As a processing velocity, specifically, the cutting is carried out under the condition of a processing velocity in a range of 100 to 2000 mm/min, specifically, 100, 250, 500, 750, 1000, 1250, 1500 and 2000. A thickness of the used reflecting mirror at that time was 5 mm. It was possible to produce a rougher cutting surface than the face in the cutting surface in any processing velocity. Furthermore, the cutting surface is unclear. As a result of this, it tended to became more rougher of doneness of the product in the cutting surface and the face, or the cutting surface and the coated layer surface as the processing velocity became high, that is, rapid cutting was carried out. That is, it was recognized that as the processing velocity became high, there was a trend toward a lot of generation of a chipping at an edge of processing face (an upper face and a lower face). As a chipping does not generate, an expensive texture tends to generate. Therefore, in the test of a range of 100 to 2000 mm/min, if it was in order of good results, it was 100 mm/min, 250 min/min, 500 mm/min, 750 mm/min, 1000 mm/min, 1250 mm/min, 1500 mm/min, 2000 min/min by rotation. Therefore, although there was some problem as to the mass productivity, it was recognized that an expensive reflecting mirror could be obtained by processing it at a slower velocity.

As a result of the above, it was recognized that it was possible to process glass and the reflecting mirror without clacking by means of in the processing of a hole of 50 mm of diameter, a portion of pierce which became a starting point was emit and penetrated by the water-jet under low pressure by the automatic function of pierce to start a processing, and thereby cutting until a desired outline and a cutting point. Therefore, it was recognized that there was some conditions of processing in a stating of a desired pierce cut in order to prevent a clacking of the reflecting mirror etc. That is, it was recognized that there are favorable conditions for manufacturing the pierce (The conditions of manufacturing pierce at the time of the starting of the cut). it was recognized that at least it was desirable to be lower value of pierce condition as to a pressure and a flow rate than that of a condition at cutting of the reflecting mirror, that is final product.

### Example 2

Next, the cutting of the reflecting mirror by the water-jet machining with the use of the polishing agent was made an attempt. The thickness of the used reflecting mirror was 5 mm. A garnet was used as the polishing agent, and those of #120 and #80 of the grain size was used. An amount of supply of the polishing agent as to the reflecting mirror was 150 g/min, and those of pierce was 60 g/min. A water pressure of the reflecting mirror was 300 MPa, and those of the cutting of so-called pierce which is not related to the product was 30 MPa. The flow rate of the reflecting mirror was 1.1 and those of the pierce was 0.35. Those of 0.2 mm of the nozzle diameter was used.

Moreover, as a result of the Example 1, although it is recognized that it is expected to give a high quality if the processing velocity is slower, it was 100 mm/min here which was a good evaluation in the Example 1.

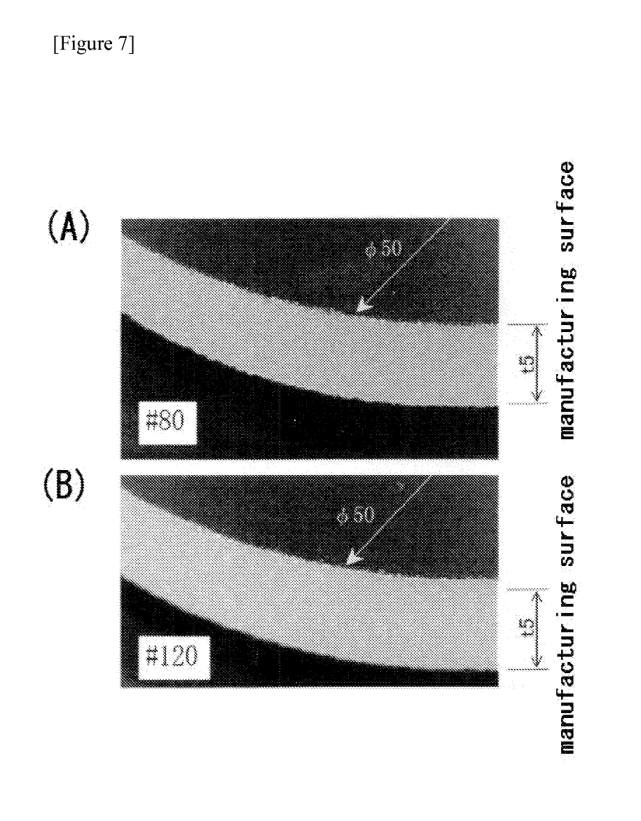

FIG. 7 gives a comparison of a cutting face of a garnet #80 and a #120 (A comparison according to a difference of a grain size of the polishing agent). (A) is in the case of #80 as a grain size of the polishing agent, (B) is in the case of #120. as a grain size of the polishing agent, respectively. It was recognized that as to the grain size, the make up products made by using #120 are excellent result of the surface roughness comparing with those of #80, if the value is lower, the make up products is rougher. Therefore, it is recognized that as the value of the grain size is larger, it become better in that case of the productivity of the reflecting mirror having a higher quality.

### Example 3

Next, the conditions for preventing a separation of the coating agent such as metal etc., of the coated layer surface of the reflecting mirror were examined. There are almost no problems of the reparation or the removal of the coated layer in the case of the table mobile type. However, it is possibility of the removal of the coating agent of the coated layer surface in the case of the apparatus wherein a stage such as a grate for mounting a processing object is needed, and a superhigh pressure water has possibility to hit against the stage to rebound it to the processing object.

Therefore, a cutting test was carried out through the protected member to the coated layer surface. A high quality sponge and glass etc., are used as the protected member. As to the thickness, those of 5 mm as to the sponge was used, and those of 2 mm as to glass was used. As a result, it was recognized that it was possible to prevent; the cutting surface from chipping or few if any and to improve the removal of the coated layer surface comparing with those of cutting without the protected member even if any protected member are used.

### Example 4

Next, in the case of the use of no protected member, and in the case that the thickness of the protected member and degree of hardness of the protected member etc., were changed in many different ways, the coated layers of the reflecting mirror for reflecting were evaluated. In addition, the conditions were also examined that on account of the extraction rate etc., it is possible to produce the reflecting mirror with the industrial productivity, the high extraction rate and the high quality.

As a test condition, a water jet machining of the abrasive jet cutter NC, and the water jet pomp (type: AJP-35025G2, made by SUGINO MACHINE LIMITED) was used. In the cutting, the pressure was 300 MPa, and the pressure of the portion of pierce was 30 MPa. In the nozzle diameter, the portion of water was 0.2 mm, the portion of pierce was 0.2 mm when cutting. In the nozzle diameter, the portion of abrasive was 0.76 mm, and the portion of pierce was 0.76 mm when cutting. As to the flow rate, it was 1.1 L/min and the portion of pierce was 0.35 L/min when cutting. Moreover, in the processing velocity was 100 mm/min when cutting. At to the amount of supply of the polishing agent, it was 150 g/min, the portion of pierce was 60 g/min when cutting. The used polishing agent was garnet #120.

Specifically, as to the protected member, those of acrylic (a thickness of 1 mm, 2 mm, 3 mm and 5 mm), those of glass (a thickness of 3 mm), and those of sponge (A thickness of 5 mm). A manufacturing configuration was an ellipsoid.

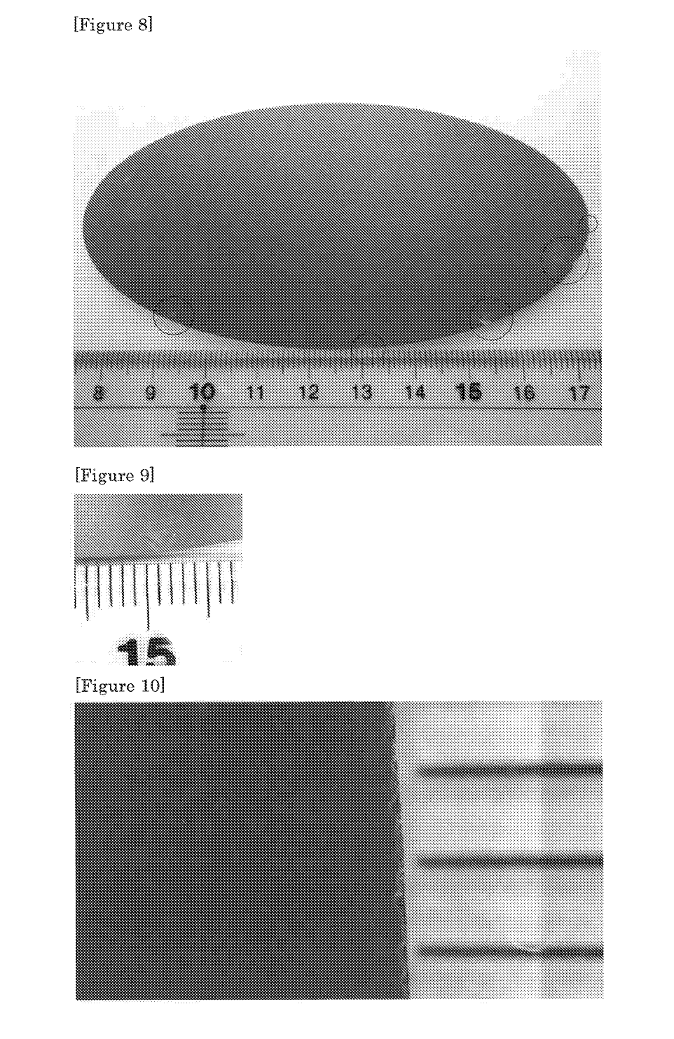

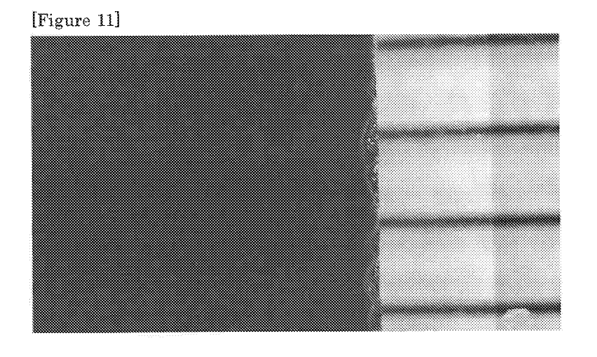

FIG. 8 gives a reflecting mirror cut by the water-jet machining without a protected member. It is recognized that an encircled portion of the figure is a trace of a scratch depending on the splattering of water from the water-jet machining, a coated layer of reflection of a reflecting mirror is broke away. A scale at the lower side of FIG. 8 is a scale wherein 1 mm is indicated on a scale. FIG. 9 gives an enlarged illustration of an encircled portion of a trace of the scratch shown in a third circle from right side of FIG. 8. It is also a scale wherein 1 mm is indicated on a scale. A size of scratch is about 3 mm at a long size. It is recognized that it is possible to distinguish the scratch by the naked eye, and it is possible to use as the reflecting mirror if the portion of scratch is covered with a flame etc. FIG. 10 gives a reflecting mirror cut by the water-jet machining through a protected member having a H or more of a pencil hardness, and a thickness of the protected member is 1 mm. 1 mm at a right side is also indicated on a scale. FIG. 11 gives a reflecting mirror cut by the water-jet machining through a protected member having a H or more of a pencil hardness, and a thickness of the protected member is 5 mm. 1 mm at a right side is also indicated on a scale.

Although concerning a degree of the removal of the coated layer for reflecting, the degree was not so concerned about in the case that it is used as a reflecting mirror by the naked eye, since it was produced by the conditions of FIG. 10 and FIG. 11, as an example, specifically, it was examined how size of scratch existed. At first, in the FIG. 10, although it was possible to measure it from figure, the length of the portion of the largest scratch was 0.113 mm, the length of the portion of the smallest scratch was 0.02 mm.

Moreover, in the FIG. 11, the length of the portion of the largest scratch was 0.204 mm, the length of the portion of the smallest scratch was 0.02 mm. Therefore, it is though that the removal is not so concerned about in the case that it is used as a reflecting mirror if the removal by scratch is about 0.5 mm or less.

Concerning the removal generated by the water jet machining, it is common things in both those of FIG. 1( )and FIG. 11 that any removal is continuous scratch and continuous [symbol] , peaks and troughs. It is not sharp peaks and troughs, but smooth and continuous peaks and troughs (wherein an angle of inclination is about 45 degree or less in both peaks and troughs). It is possible to read from figure that a depth of the scratch as to such peaks and troughs is within a range of about less than 0.5 mm.

Moreover, although it was not shown in the figure, it was recognized that a resin plate of a pencil hardness of B, HB, H and 2H according to the standard of JIS K5600-5-4 was examined, and as a result, a resin plate of a pencil hardness of H or more was excellent.

As mentioned above, in the past although the water jet cutter was used to the cutting of the stone etc., it was not used for the cutting of the reflecting mirror. Furthermore, it was not used for the cutting of a complicated designed product.

However, in the present embodiment, the use of the water jet cotter for the reflecting mirror makes it possible to manufacture a reflecting mirror with a high accuracy without cracking.

And furthermore, it is possible to combine a reflecting mirror having a different color of reflection manufactured with a complicated design to produce a various sort of a new ornament from small size to large size such as all of the wall surface.

And then, it is possible to combine a reflecting mirror having a different color of reflection manufactured with a complicated design to produce a hand mirror, a compact mirror, a wall decoration by character, an interior decorating of store and an interior decorating of a lobby of hotel.

### INDUSTRIAL APPLICABILITY

Although a reflecting mirror has regular series of the shapes such as a circle type and a quadrangle type, since the present invention makes it possible to carry out a complicated design cutting and to produce an ornament having a high quality, it is possible to contribute to a very broad fields.

### EXPLANATION OF REFERENCES

1 to 16 A part
20 An outlet of a superhigh pressure water
21 An abrasive nozzle
22 A feed port of an abrasive
23 A water nozzle
24 A feed port of a superhigh pressure water
31 An abrasive head (capable of moving for a direction of y-axis)
32 An object of processing (capable of moving for a direction of x-axis)
33 A work stopper
34 A slit catcher (fixed)
41 An abrasive head (capable of moving for a direction of x and y-axis)
42 An open catcher (fixed)
43 A stage
44 A catcher tank

1. A method of manufacturing a reflecting mirror, having a light transmittance medium capable of transmitting a light and a coated layer surface for reflecting light which is placed at the light transmittance medium, wherein the light transmittance medium is cut by a water jet machining through a protected member set at a coated face side of the coated layer surface.

2. A method according to claim 1, wherein a pencil hardness of the protected member is a H or more.

3. A method according to claim 1, wherein the cutting by the water jet machining is carried out under the presence of a polishing agent.

4. A method according to claim 1, wherein the cutting by the water jet machining is carried out under the condition of a water pressure in a range of 10 to 500 MPa.

5. A method according to claim 1, wherein the cutting by the water jet machining is carried out under the condition of a processing velocity in a range of 1 to 15000 mm/min.

6. A method according to claim 1, wherein an amount of supply of the polishing agent is 10 to 300 g/min.

7. A reflecting mirror having a light transmittance medium capable of transmitting a light and a coated layer surface for reflecting light which is placed at the light transmittance medium, wherein in the case that a face opposite to the coated layer surface is a face of the light transmittance medium, the reflecting mirror has a cutting surface other than the coated layer surface and the face, and a surface roughness of the cutting surface is rougher than the face, and the cutting surface is a cutting surface which is cut by the water-jet machining through a protected member set at a coated face side of the coated layer surface.

8. A reflecting mirror according to claim 7, wherein a pencil hardness of the protected member is a H or more.

9. A reflecting mirror according to claim 7, wherein the cutting surface is a surface cut by the water jet machining under the presence of a polishing agent.

10. A reflecting mirror according to claim 7, wherein the light transmittance medium is made of glass or acrylic.

11. An ornament reflecting mirror, wherein the ornament reflecting mirror is made by combination of a part which is made by the reflecting mirror according to claim 7.

12. An ornament reflecting mirror according to claim 11, wherein the part is a mirror having a different color of reflection.
